(19) United States
(12) Patent Application Publication
(10) Pub. No.: US 2009/0193927 A1
(43) Pub. Date: Aug. 6, 2009

(54) Locking device of a bicycle brake cable

(76) Inventor: Szu-Fang Tsai, Changhua (TW)

Correspondence Address: SAM CHEN, 7F-1, 293, ROOSEVELT ROAD, SEC 3, TAIPEI, TW

(21) Appl. No.: 12/024,993

(22) Filed: Feb. 1, 2008

(51) Int. Cl. F16C 1/10

(52) U.S. Cl. 74/502.6

(57) ABSTRACT

A locking device of a bicycle brake cable includes a locking portion including a through hole defined therein. The locking portion has a hole and a threaded hole defined therein and communicating with the through hole, wherein the threaded hole extends to an outer periphery of the locking portion. A clamping device is mounted in the locking portion. The clamping device includes a first clamping block, a second clamping block and a drive piece. The first clamping block is partially and securely received in the hole and extending into the through hole. The second clamping block is and pivotally mounted to the drive piece and faces the first clamping block, the drive piece having a threaded outer periphery and screwed into the threaded hole with the second clamping block, the drive piece drives the second clamping block moved toward the first clamping block for securely clamping the brake cable.

### BACKGROUND OF THE INVENTION

1. Field of the Invention

The present invention relates to a locking device, and more particularly to a locking device of a bicycle brake cable.

2. Description of Related Art

As well known, a brake system of a bicycle includes a brake cable connected to a brake handle that is pivotally mounted on a handlebar. The brake cable drives a brake device for braking the wheel when the brake handle is operated to pull the brake cable. The conventional locking way uses a bolt to directly force the brake cable. However, the brake cable is woven by multiple thin wires such that the woven thin wires may be torn due to a gradually increasing torsion from the bolt during locking brake cable. The torn brake cable may be broken during operation or deformed and can not be recycled. As a result, some brake manufacturers use a clamping device for locking the brake cable. However, a bolt is still necessary to the clamping device. The exposed bolt influences the completeness of the brake device and may hook the rider's clothes. The clamping device can prevent the brake cable from being overly torn. However, the clamping device still has some disadvantages and needs to be advantageously altered.

The present invention has arisen to mitigate and/or obviate the disadvantages of the conventional locking devices of a bicycle brake cable.

### SUMMARY OF THE INVENTION

The main objective of the present invention is to provide an improved locking device of a bicycle brake cable that can prevent the brake cable from being overly deformed.

To achieve the objective, the locking device in accordance with the present invention comprises a locking portion including a through hole defined therein. The locking portion has a hole and a threaded hole defined therein and communicating with the through hole, wherein the threaded hole extends to an outer periphery of the locking portion. A clamping device is mounted in the locking portion. The clamping device includes a first clamping block, a second clamping block and a drive piece. The first clamping block is partially and securely received in the hole and extending into the through hole. The second clamping block is and pivotally mounted to the drive piece and faces the first clamping block, the drive piece having a threaded outer periphery and screwed into the threaded hole with the second clamping block, the drive piece drives the second clamping block moved toward the first clamping block for securely clamping the brake cable.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a locking device of a bicycle brake cable in accordance with the present invention;

FIG. 2 is an exploded perspective view of the locking device of the present invention;

FIG. 3 is a cross-sectional view of the locking device of the present invention;

FIG. 4 is an operational view of the locking device of the present invention; and

FIG. 5 is another cross-sectional view of the locking device of the present invention for showing the brake cable being locked.

### DETAILED DESCRIPTION OF THE INVENTION

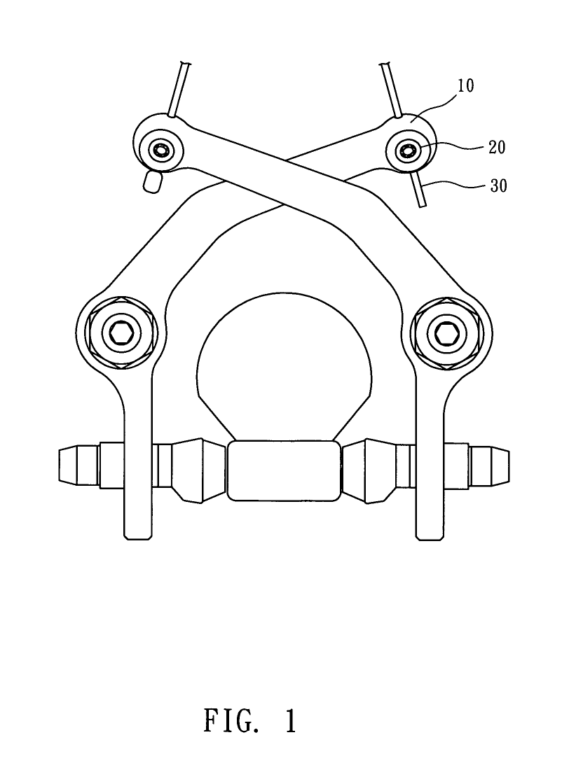

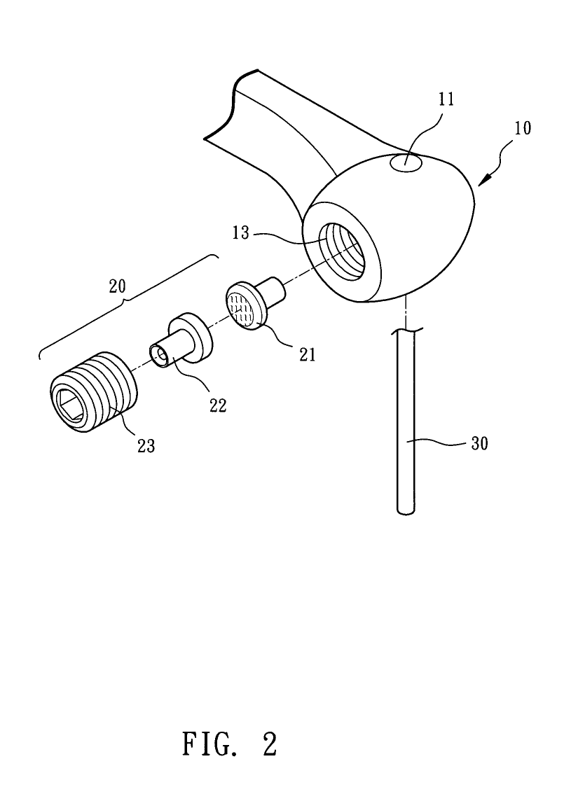

Referring to the drawings and initially to FIGS. 1-4, a locking device of a bicycle brake cable in accordance with the present invention comprises a locking portion (10) formed on a brake arm of the bicycle and a clamping device (20) mounted in the locking portion (10).

The locking portion (10) includes a through hole (11) defined therein, wherein the through hole (11) is defined to correspond with a operation direction of the brake cable (30) to prevent the brake cable (30) from being curved and ensure that the brake cable (30) has a smooth operation. The locking portion (10) has a hole (12) and a threaded hole (13) respectively defined therein and communicating with the through hole (11). The hole (12) and the threaded hole (13) linearly correspond to each other. An axis of the hole (12) and the threaded hole (13) orthogonally crisscrossed with that of the through hole (11). In addition, the threaded hole (13) extends to an outer periphery of the locking portion (10).

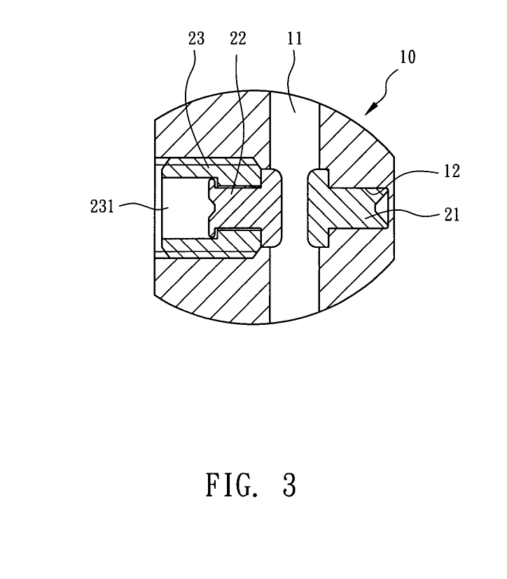

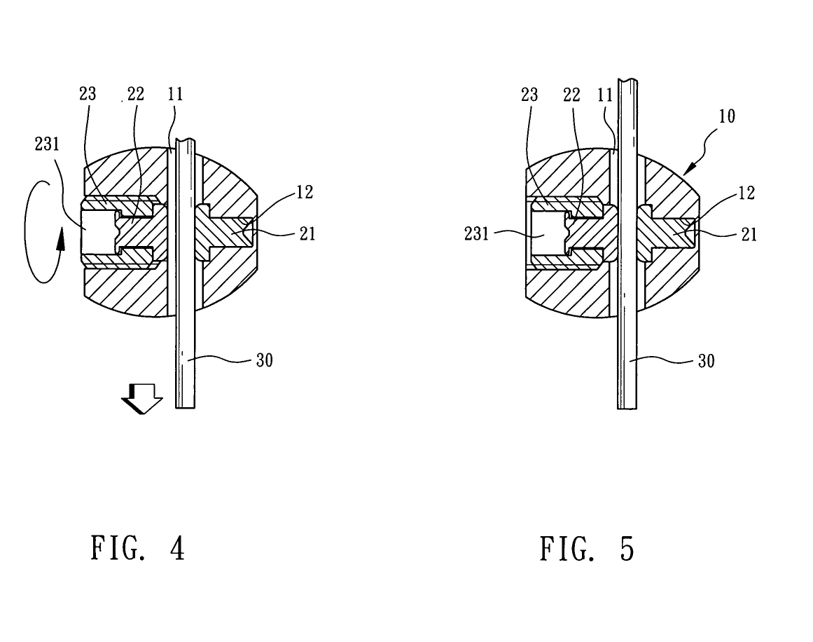

The clamping device (20) includes a first clamping block (21), a second clamping block (22) and a drive piece (23). The first clamping block (21) is partially and securely received in the hole (12) and radially extends into the through hole (11). The second clamping block (22) is longitudinally and pivotally mounted to the drive piece (23) and faces the first clamping block (21). The drive piece (23) has a threaded outer periphery and is screwed into the threaded hole (13) with the second clamping block (22). The drive piece (23) has a polygonal hole (231) longitudinally defined therein opposite to the second clamping block (22) for user to easily operate the drive piece (23) and make the second clamping block move toward the first clamping block (21) for securely clamping the brake cable (30), as shown in FIGS. 4 and 5. Each of the first clamping block (21) and the second clamping block (22) has a contact face contact with the brake cable (30) and the contact faces are patterned for enhancing the friction among the brake cable (30) and the two clamping block (21, 22). With reference to FIGS. 3 and 4, the second clamping block (22) extends into the polygonal hole (231) and the distal end of the second clamping block (22) in the polygonal hole (231) is riveted to prevent the second clamping block (22) from detaching from the drive piece.

Although the invention has been explained in relation to its preferred embodiment, it is to be understood that many other possible modifications and variations can be made without departing from the spirit and scope of the invention as hereinafter claimed.

What is claimed is:

1. A locking device of a bicycle brake cable, comprising:
a locking portion including a through hole defined therein and corresponding with a operation direction of the brake cable, the locking portion having a hole and a threaded hole respectively defined therein and communicating with the through hole, the hole and the threaded hole linearly corresponding to each other, an axis of the hole and the threaded hole orthogonally crisscrossed with that of the through hole, and the threaded hole extending to an outer periphery of the locking portion; and
a clamping device mounted in the locking portion, the clamping device including a first clamping block, a second clamping block and a drive piece, the first clamping block partially and securely received in the hole and radially extending into the through hole, the second clamping block longitudinally and pivotally mounted to the drive piece and faces the first clamping block, the drive piece having a threaded outer periphery and screwed into the threaded hole with the second clamping block, the drive piece having a polygonal hole longitudinally defined therein opposite to the second clamping block for user to easily operate the drive piece and make the second clamping block move toward the first clamping block for securely clamping the brake cable.

2. The locking device as claimed in claim 1, wherein the locking portion is adapted to be formed on a brake arm of the bicycle.

3. The locking device as claimed in claim 1, wherein each of the first clamping block and the second clamping block has a contact face contact with the brake cable and the contact faces are patterned for enhancing the friction among the brake cable and the two clamping block.
